(19) United States
(12) Patent Application Publication
(10) Pub. No.: US 2015/0205925 A1
(43) Pub. Date: Jul. 23, 2015

(54) METHOD AND SYSTEM OF RETRIEVING HEALTHCARE INFORMATION

(71) Applicant: HTH WORLDWIDE LLC, Radnor, PA (US)

(72) Inventors: Angelo MASCIANTONIO, Radnor, PA (US); Alex WOOD, Radnor, PA (US); Janet HNAT, Radnor, PA (US)

(73) Assignee: HTH WORLDWIDE LLC, Radnor, PA (US)

(21) Appl. No.: 14/160,691

(22) Filed: Jan. 22, 2014

(51) Int. Cl. G06F 19/00

(52) U.S. Cl. CPC G06F 19/328

(57) ABSTRACT

A method of retrieving healthcare information includes at a computer having one or more processors and memory for storing one or more programs to be executed by the processors: receiving a query for a service charge in connection with a member from a user terminal; assigning a case number to the query for a service charge; transmitting the query for a service charge to a healthcare insurer; receiving a response to the query for the service charge in connection with the member from the healthcare insurer; generating guarantee of payment (GOP) data in accordance to the response to the query for the service charge in connection with the member; logging the GOP data in a database; and outputting the GOP data to the user terminal.

### FIELD OF THE INVENTION

The present invention relates to the technical field of healthcare information, in particular, relates to a method and system of retrieving healthcare information.

### BACKGROUND OF THE INVENTION

Inside the United States, a healthcare insurance plan member is accustomed to the experience of walking into a doctor's office or hospital, presenting an ID card and paying any co-pays and/or deductibles for which he or she is responsible. The doctor or the hospital then claims the service charge to the healthcare insurer and bills the insurer for any remaining costs. Outside the United States, however, it is rare for healthcare providers to bill insurers for services. Providers generally do not have a mechanism to verify eligibility and benefits for members, and if they fail to collect payment up-front and provide services to a member who does not have healthcare benefits, they have virtually no ability to collect payment from the member once he or she has left the office. Providers therefore typically require payment in full from members at the time that the healthcare service is rendered.

International healthcare insurers are increasingly working to enable a “direct pay” or “cashless” experience for their members outside of the United States for both inpatient and outpatient services. They typically do this by providing prospectively a written “Guarantee of Payment” (GOP) to providers which sets forth the specific amounts that they will pay to a provider for a particular service. The specific amounts may or may not reflect a maximum payment. The process that they often use to generate a written GOP is extremely manual and highly costly. It also usually requires the member to contact his or her insurance carrier in advance of receiving treatment from the doctor to request a written GOP.

### SUMMARY

The present invention provides a method and system to automate and expedite issuance of a written GOP to create a cashless experience for patients all around the world. The so-called mCard system may allow for the member or provider to initiate an electronic request for a guarantee of payment. Members may submit a request for a guarantee of payment via a web-based member portal or a downloadable mobile device application, such as iPhone, Android phone, iPad application etc. Providers may submit a request for guarantee of payment using a provider portal. Both members and providers may also contact the mCard system customer service directly via phone or e-mail to request a GOP. The mCard system may return a guarantee of payment directly to the mobile device compatible application, member portal and provider portal for most low-cost outpatient procedures without human-intervened process. For more expensive outpatient procedures and all inpatient procedures, the mCard system may apply business logic to route the request to a case manager to review for medical necessity and appropriate setting. The GOP may set forth the specific amounts that the member will pay to a provider for a particular service, or a maximum amount for the GOP so as to allow flexibility for the providers' charges but also limit the insurer's potential costs. It is therefore possible for a member to walk directly into a doctor's office, request a GOP using a mobile phone, receive a response back in less than thirty seconds, pay his or her co-pay or deductible to the doctor and receive treatment on a cashless basis.

Further, GOP data may be automatically converted to the appropriate language and currency based on the provider's location before it is displayed on the member's mobile device or the provider's portal according to the present invention. Therefore, it is possible for international healthcare insurers to provide cashless service for their members outside of the United States. The convenience and reliability of the process encourages adoption by patients and providers alike.

In accordance with some embodiments, a method of retrieving healthcare information comprises a computer having one or more processors and memory for storing one or more programs to be executed by the processors for receiving a query for a service charge in connection with a member from a user terminal; assigning a case number to the query for a service charge; transmitting the query for a service charge to a healthcare insurer; receiving a response to the query for the service charge in connection with the member from the healthcare insurer; generating guarantee of payment (GOP) data in accordance to the response to the query for the service charge in connection with the member; logging the GOP data in a database; and outputting the GOP data to the user terminal.

In accordance with some embodiments, the healthcare insurer may be configured with a gateway computer or an administrative interface that acts on behalf of the insurer to receive and respond to the query for the service charge in connection with the member.

In accordance with some embodiments, the method of retrieving healthcare information further comprises applying language and currency conversions to the GOP data in accordance to a location where the service is provided.

In accordance with some embodiments, the method of retrieving healthcare information further comprises applying business logic on the query for a service charge based on a plurality of factors, and transmitting the query for a human-intervened review before generating the GOP data.

In accordance with some embodiments, the business logic which determines whether or not the GOP can be generated without human intervention may be based on the service type, for example, when the service is an inpatient procedure or an outpatient procedure with cost exceeding a pre-determined amount, the query is transmitted for a human-intervened review before generating the GOP data.

In accordance with yet some embodiments, the business logic which determines whether or not the GOP can be generated without human intervention may be based on the services chosen and whether or not they have clear benefit description in the insurance policy or certificate. The insurer may choose to implement any business logic to determine if a human-intervened review is necessary, such as the provider location, the provider type, the service type, the service cost, or any combinations of thereof.

In accordance with some embodiments, the user terminal may comprise a website browsing terminal for members or healthcare providers, a mobile optimized website, a mobile device compatible application, or an administrative interface.

In accordance with some embodiments, the method of retrieving healthcare information may be implemented as a web-based service or an application programming interface (API) where the insurer or a third party applies the front end design and interface.

In accordance with some embodiments, the query for a service charge and the response for a service charge are paired transactions configured to comply with a pre-defined format. In the United States, the query for a service charge and the response for a service charge are paired transactions that comply with health level 7 (HL-7) standards. The present invention is not limited to standards. In accordance with some embodiments, for example, when a medical service takes place outside the United States, the paired transactions of the query for a service charge and the response for a service charge may be configured to comply with proprietary formats, as will be known to those skilled in art.

In accordance with some embodiments, the GOP data includes a member responsible charge of the service.

In accordance with some embodiments, the GOP data may further include accumulating information such as the number of visits year to date, a complete estimated charge for the queried service, contact information, document list required to be submitted together with the confirmed GOP, etc.

In accordance with some embodiments, the GOP data is configured to be able to share among the member, the healthcare insurer, the service provider, and a third party administrator.

In accordance with some embodiments, providers may submit a request for guarantee of payment using a provider portal. Both members and providers may also contact the mCard system customer service directly via phone or e-mail to request a GOP.

In accordance with some embodiments, a system of retrieving healthcare information comprises one or more processors; memory for storing one or more programs to be executed by the processors; a front-end receiver configured to receive a query for a service charge in connection with a member from a user terminal; a query processor configured to assign a case number to the query for a service charge; a rear-end transmitter configured to transmit the query for a service charge to a healthcare insurer; a rear-end receiver configured to receive a response to the query for the service charge in connection with the member from the healthcare insurer; a GOP processor configured to generate guarantee of payment (GOP) data in accordance to the response for the service charge in connection with the member; a register configured to log the GOP data in the database; and a front-end transmitter configured to output the GOP data to the user terminal.

In accordance with some embodiments, the system of retrieving healthcare information further comprises a region converter configured to apply language and currency conversions to the GOP data in accordance to a location where the service is provided.

In accordance with some embodiments, the system of retrieving healthcare information further comprises a business logic module configured to apply business logic on the query for a service charge based on a plurality of factors, and transmitting the query for a human-intervened review before generating the GOP data.

In accordance with some embodiments, the business logic which determines whether or not the GOP can be generated without human intervention may be based on the service type, for example, when the service is an inpatient procedure or an outpatient procedure with cost exceeding a pre-determined amount, the system transmits the query for a human-intervened review before generating the GOP data.

In accordance with yet some embodiments, the business logic which determines whether or not the GOP can be generated without human intervention may be based on the services chosen and whether or not they have clear benefit description in the insurance policy or certificate. The insurer may choose to implement any business logic to determine if a human-intervened review is necessary, such as the provider location, the provider type, the service type, the service cost, or any combinations of thereof.

In accordance with some embodiments, the system of retrieving healthcare information may further provide a confirmation receipt of the GOP and monitor the confirmation status of the GOP.

In accordance with some embodiments, a non-transitory computer readable storage medium, storing one or more programs for execution by one or more processors of a computer system, the one or more programs includes instructions for: receiving a query for a service charge in connection with a member from a user terminal; assigning a case number to the query for a service charge; transmitting the query for a service charge to a healthcare insurer; receiving a response to the query for the service charge in connection with the member from the healthcare insurer; generating guarantee of payment (GOP) data in accordance to the response to the query for the service charge in connection with the member; logging the GOP data in a database; and outputting the GOP data to the user terminal.

In accordance with some embodiments, the one or more programs further comprises applying language and currency conversions to the GOP data in accordance to a location where the service is provided.

In accordance with some embodiments, the one or more programs further comprises applying business logic on the query for a service charge based on a plurality of factors, and transmitting the query for a human-intervened review before generating the GOP data.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention. In the drawings:

FIG. 1 illustrates an exemplary embodiment of a system of retrieving healthcare information in accordance with the present invention;

FIG. 2 illustrates an exemplary embodiment of user terminals in a system of retrieving healthcare information in accordance with the present invention;

FIG. 3 illustrates an exemplary embodiment of a detailed mCard system in a system of retrieving healthcare information in accordance with the present invention;

FIG. 4 illustrates an exemplary computer diagram of a system of retrieving healthcare information in accordance with the present invention;

FIG. 5 illustrates an exemplary flowchart diagram of a system of retrieving healthcare information in accordance with the present invention.

FIG. 6 illustrates another exemplary flowchart diagram of a method of retrieving healthcare information in accordance with the present invention.

FIG. 7 illustrates yet another exemplary flowchart diagram of a method of retrieving healthcare information in accordance with the present invention.

FIG. 8 illustrates an exemplary outpatient service confirmed guarantee of payment in accordance with the present invention.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous non-limiting specific details are set forth in order to assist in understanding the subject matter presented herein. It will be apparent, however, to one of ordinary skill in the art that various alternatives may be used without departing from the scope of the present invention and the subject matter may be practiced without these specific details. For example, it will be apparent to one of ordinary skill in the art that the subject matter presented herein can be implemented on any type of system to retrieve healthcare information.

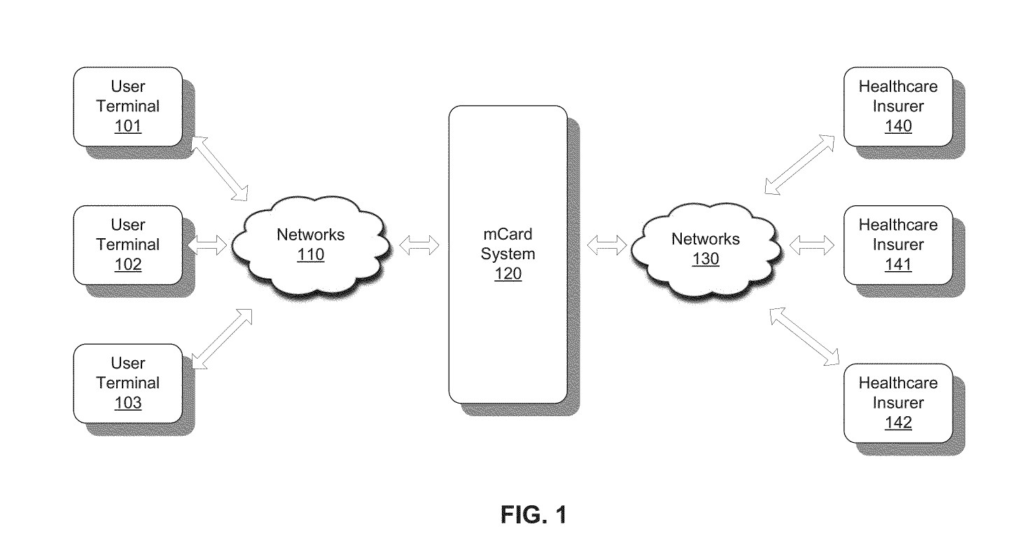

FIG. 1 illustrates an exemplary embodiment of a system of retrieving healthcare information in accordance with the present invention. The exemplary embodiment 100 may comprise a plurality of user terminals 101, 102, 103, etc., networks 110, an mCard system 120, networks 130 and a plurality of healthcare insurers 140, 141 and 142, etc. The user terminal is configured to send a query for a healthcare service charge in connection with a member to the mCard system 120 via networks 110. In some embodiments, networks 110 may comprise local area network (LAN), wide area network (WAN) and mobile communication network. Upon receiving the query for a service charge, the mCard system 120 may process the query for a service charge and transmit the query to a healthcare insurer of the member via networks 130. The healthcare insurer may return a response to the query for a service charge to the mCard system 120. Upon receiving the response to the query for a service charge, the mCard system 120 may generate guarantee of payment (GOP) data based on the response content. The mCard system 120 may further log the generated GOP data in a database, and output the GOP data to the user terminal.

In some embodiments, the healthcare insurer may be further configured with a gateway computer or an administrative interface that actually acts on behalf of the healthcare insurer to receive and respond to the query for the service charge in connection with the member.

In some embodiments, the mCard system 120 may apply business logic to the query for a service charge before transmitting the query to the healthcare insurer based on a plurality of factors, and transmitting the query for a human-intervened review before generating the GOP data. For example, if the queried service is a low-cost office visit or an outpatient procedure, the mCard system 120 may directly return the GOP data to the user terminal; and if the queried service is an inpatient procedure or an outpatient procedure with cost exceeding a pre-determined amount, the business logic may route the query for a service charge for a human-intervened review to determine medical necessity and apply appropriate settings of the GOP data.

In some embodiments, the mCard system 120 may obtain a location where the service is provided, and apply language and currency conversion to the GOP data in accordance to a location where the healthcare service is provided. Thus the GOP data is automatically converted to the appropriate language and currency when it is displayed on the user terminal.

In some embodiments, the mCard system 120 may be designed using Service Oriented Architecture (SOA) so that it is reusable for different insurers, i.e., not only Blue Cross Blue Shield (BCBS) members, for example.

In some embodiments, for insurers based inside the United States, the query for a service charge and the response to the query for a service charge are paired transactions configured to comply with the federally mandated health level 7 (HL-7) standards. The present invention is not limited to standards. In accordance with some embodiments, for example, when a medical service takes place outside the United States, the paired transactions of the query for a service charge and the response for a service charge may be configured to comply with proprietary formats, as will be known to those skilled in art. Yet in some other embodiments, the mCard system 120 may be integrated with insurers located outside the United States with international systems and using application programming interfaces (APIs).

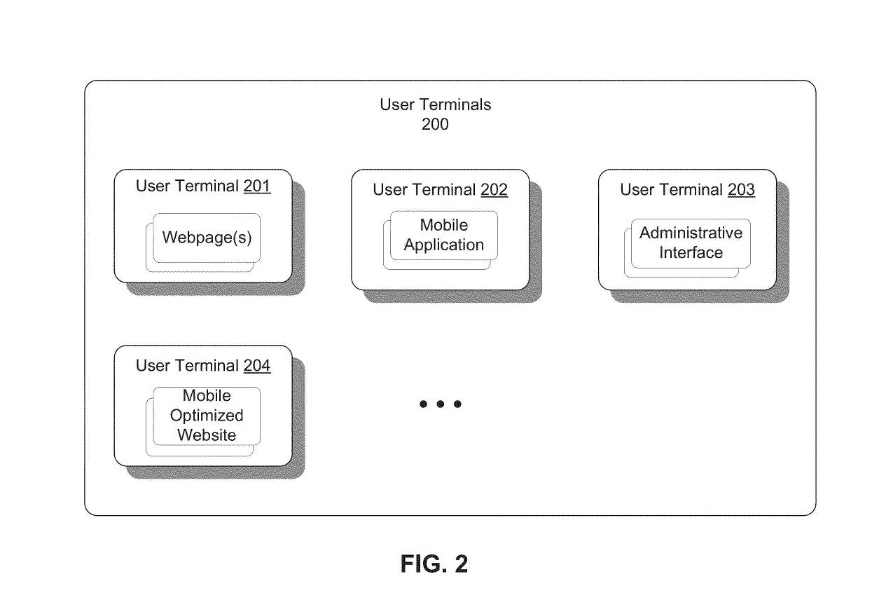

FIG. 2 illustrates an exemplary embodiment of user terminals in a system of retrieving healthcare information in accordance with the present invention. The user terminals 200 may comprise a website browsing terminal 201 for members or healthcare providers, a mobile device compatible application 202, an administrative interface 203, or a mobile optimized website 204 etc. The website browsing terminal 201 may include, for example, a desktop personal computer (PC), a laptop, a mobile device, and a work station, etc. In some embodiments, the query for a service charge may be sent from an application installed on a smart phone, a personal digital assistant (PDA), a tablet, etc. In yet another embodiment, the query for a service charge may be sent from an administrative interface operated on an mCard system server computer. A healthcare member or a healthcare provider may request a GOP via those user terminals. Further, in some embodiments, both the member and the provider may contact the mCard customer service directly via telephone or e-mail to request a GOP, and such request may be sent manually to a corresponding healthcare insurer via the administrative interface.

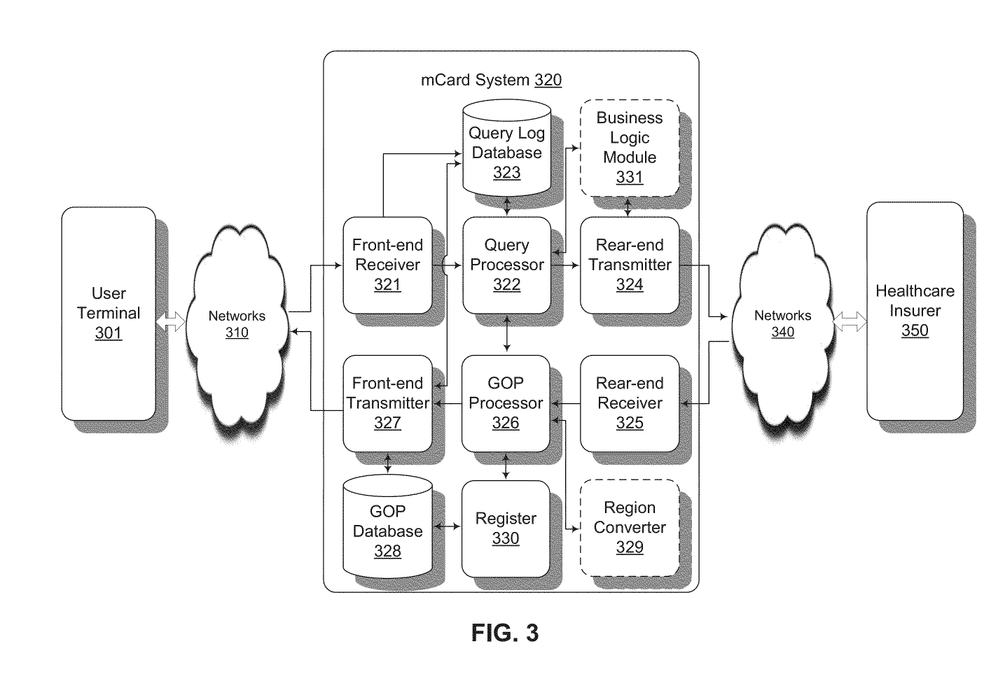

FIG. 3 illustrates an exemplary embodiment of a detailed mCard system in a system of retrieving healthcare information in accordance with the present invention. The exemplary embodiment 300 may comprise a user terminal 301, networks 310, mCard system 320, networks 340 and a healthcare insurer 350. The mCard system 320 may further comprise a front-end receiver 321 configured to receive a query for a service charge in connection with a member from the user terminal 301; a query processor 322 configured to process and assign a case number to the query for a service charge; a rear end transmitter 324 configured to transmit the query for a service charge to a healthcare insurer; a rear-end receiver 325 configured to receive a response to the query for the service charge in connection with the member from the healthcare insurer; a GOP processor 326 configured to generate GOP data in accordance to the response for the service charge in connection with the member; a register 330 configured to log the GOP data in a GOP database 328; and a front-end transmitter 327 configured to output the GOP data to the user terminal. In some embodiments, the query for a service charge may be logged in a query log database 323.

In some embodiments, the mCard system 320 may further comprise a region converter 329 configured to apply language and currency conversion to the GOP data in accordance to a location where the service is provided. Accordingly, the GOP data may be automatically converted to the appropriate language and currency settings based on the provider's location when it is outputted and displayed on the user terminal 301.

In some embodiments, the mCard system 320 may further comprise a business logic module 331 configured to apply business logic on the query for a service charge based on a plurality of factors, and transmitting the query for a human-intervened review before generating the GOP data. For example, when the query for a service charge is a low-cost office visit or an outpatient procedure, the mCard system 320 may directly return the GOP data to the user terminal 301; and when the queried service is an inpatient procedure or an outpatient procedure with cost exceeding a pre-determined amount, the business logic module 331 may route the query for a service charge for a human-intervened review to determine medical necessity and apply appropriate settings of the GOP data.

In some embodiments, the healthcare insurer 340 may be further configured with a gateway computer or an administrative interface that actually acts on behalf of the healthcare insurer to receive and respond to the query for the service charge in connection with the member.

In some embodiments, the query for a service charge may be logged in the query log database 323 and the generated GOP data may be logged in the GOP database 328. When a user, e.g., a member, sends a query for a particular service charge accompanied by insurance information of a member, the query processor 322 assigns a case number to the query for the particular service charge and logs the query in the query log database 323. Later, when the response to the query for the particular service charge is received from the healthcare insurer 340, the GOP processor 326 generates a GOP based on the response and logs the GOP in the GOP database 328 via the register 330. Further, when another user, e.g., a provider, sends a query for the same particular service charge in connection with the same member, the query processor 322 may search the query log database 323 to determine whether there is a matched query within a pre-determined time period. If a match in the query log database 323 is found, the GOP processor may retrieve the logged GOP that corresponds to the query for the particular service charge and return the GOP directly to the provider. According to some embodiments, all parties that have access to the mCard system 320 may share the GOP data in connection with a particular service and a particular member in an identical view, thus enhancing understandings between the member and the service provider.

In some embodiments, the mCard system 320 may further provide a confirmation receipt of the GOP and monitor the confirmation status of the GOP.

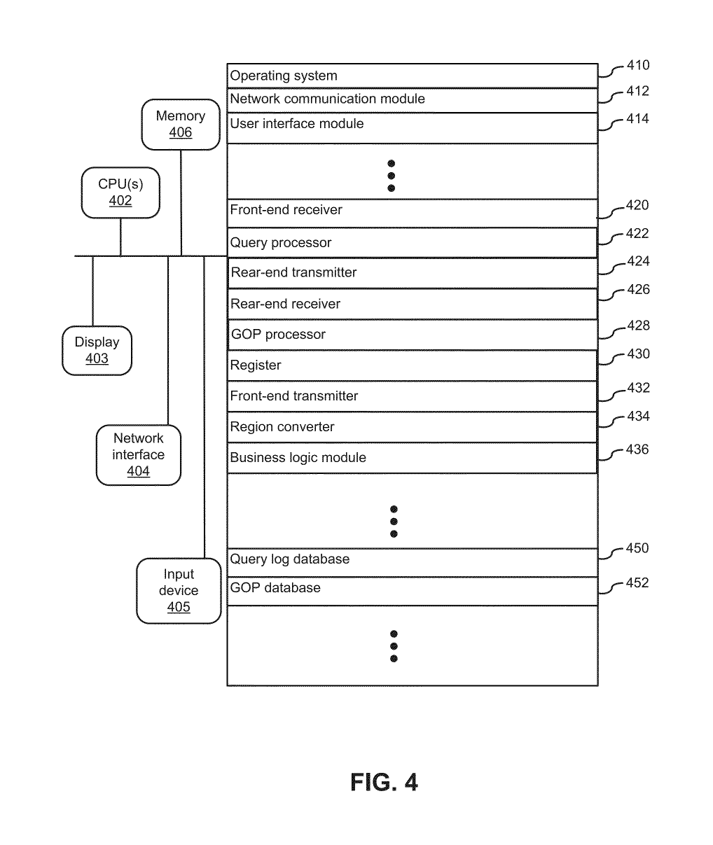

FIG. 4 illustrates an exemplary computer diagram of a system of retrieving healthcare information in accordance with the present invention. The system of retrieving healthcare information may comprise CPU(s) 402, a display 403, a network interface 404, an input device 405, a memory 406, an operating system 410, a network communication module 412, a user interface module 414, a front-end receiver 420 configured to receive a query for a service charge in connection with a member from a user terminal, a query processor 422 configured to assign a case number to the query for a service charge, a rear-end transmitter 424 configured to transmit the query for a service charge to a healthcare insurer, a rear-end receiver 426 configured to receive a response to the query for the service charge in connection with the member from the healthcare insurer, a GOP processor 428 configured to generate GOP data in accordance to the response for the service charge in connection with the member, a register 430 configured to log the GOP data in the database, a front-end transmitter 432 configured to output the GOP data to the user terminal, a region converter 434 configured to apply language and currency conversion to the GOP data in accordance to a location where the service is provided, and a business logic module 426 configured to apply business logic on the query for a service charge and transmit the query for a human-intervened review when the service is an inpatient procedure or an outpatient procedure with cost exceeding a pre-determined amount. The system of retrieving healthcare information may further comprise a query log database 450 configured to log the query for a service charge and a GOP database 452 configured to log the GOP that corresponds to the query for a service charge.

In accordance with some embodiments, the system of retrieving healthcare information may be implemented as a web-based service or an application programming interface (API) where the insurer or a third party applies the front end design and interface.

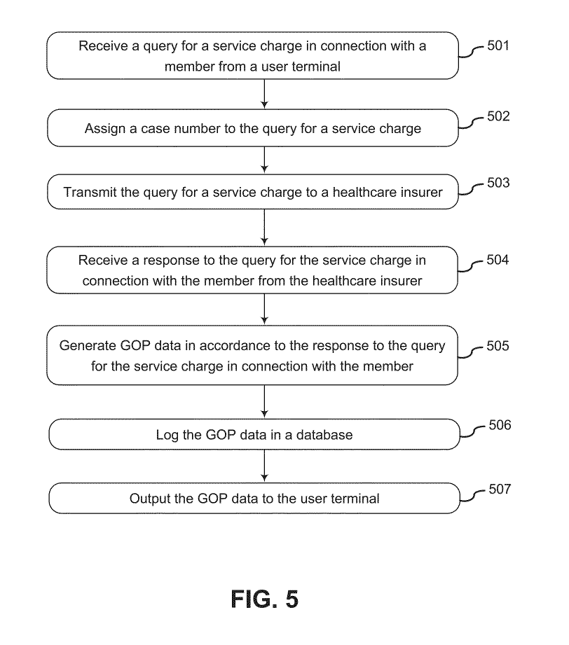

FIG. 5 illustrates an exemplary flowchart diagram of a method of retrieving healthcare information in accordance with the present invention. The method of retrieving healthcare information may comprise receiving a query for a service charge in connection with a member from a user terminal 501; assigning a case number to the query for a service charge 502; transmitting the query for a human-intervened review 503; receiving a response to the query for the service charge in connection with the member from the healthcare insurer 504; generating GOP data in accordance to the response to the query for the service charge in connection with the member 505; logging the GOP data in a database 506; and outputting the GOP data to the user terminal 507. In some embodiments, the method of retrieving healthcare information may further comprise providing a confirmation receipt of the GOP and monitoring the confirmation status of the GOP.

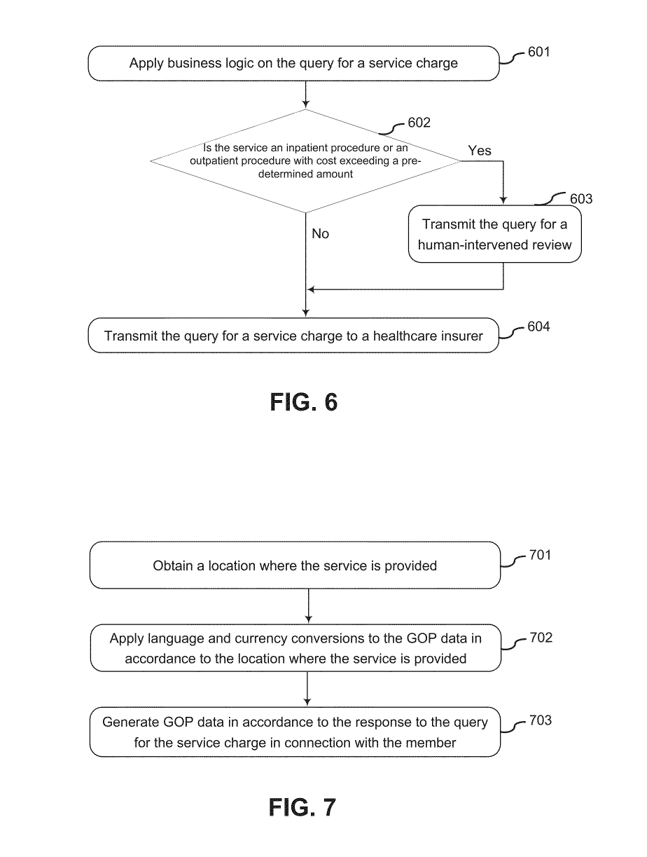

FIG. 6 illustrates another exemplary flowchart diagram of a method of retrieving healthcare information in accordance with the present invention. The method of retrieving healthcare information may further comprise applying business logic on the query for a service charge 601; determining the service type, i.e., whether the service is an inpatient procedure or an outpatient procedure with cost exceeding a pre-determined amount 602; if the procedure is an inpatient or a high cost outpatient procedure, transmitting the query for a human-intervened review 603; and if not, transmitting the query for a service charge to a healthcare insurer 604.

In accordance with yet some embodiments, the business logic that determines whether the GOP can be generated without human intervention may be based on the services chosen and whether they have clear benefit description in the insurance policy or certificate. The insurer may choose to implement any business logic to determine if a human-intervened review is necessary, such as the provider location, the provider type, the service type, the service cost, or any combinations of thereof.

FIG. 7 illustrates yet another exemplary flowchart diagram of a method of retrieving healthcare information in accordance with the present invention. The method of retrieving healthcare information may further comprise obtaining a location where the service is provided 701; applying language and currency conversion to the GOP data in accordance to the location where the service is provided 702; and generating GOP data in accordance to the response to the query for the service charge in connection with the member.

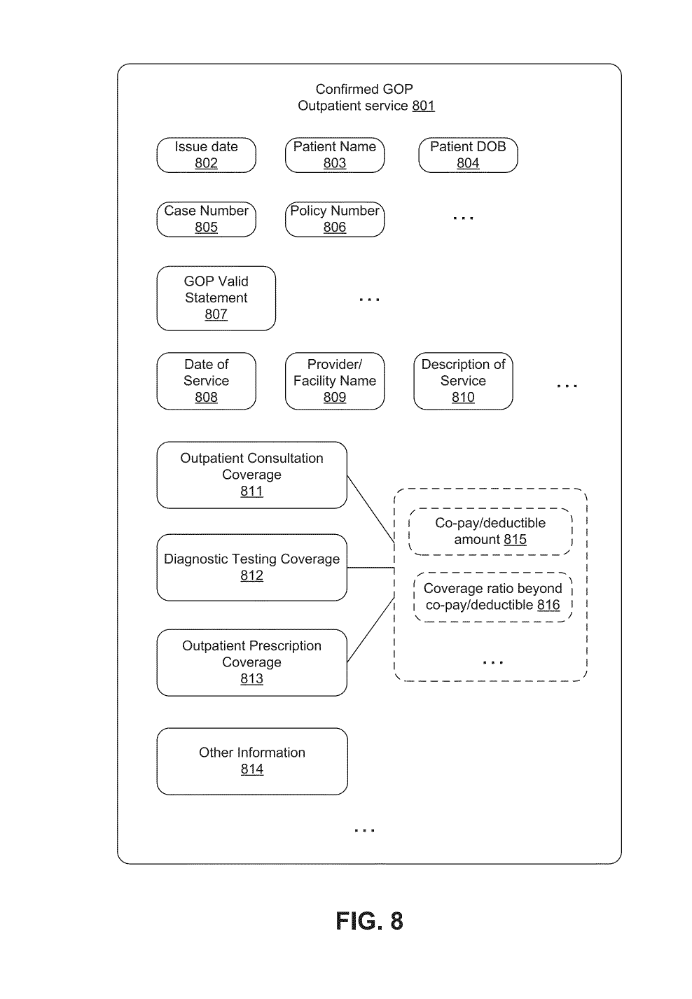

FIG. 8 illustrates an exemplary outpatient service confirmed guarantee of payment in accordance with the present invention. An outpatient service confirmed GOP data 801 may comprise an issue date field 802, a patient name field 803, a patient date of birth field 804, a case number field 805, a policy number field 806, a GOP valid statement field 807, a date of service field 808, a provider/facility name field 809, a description of service field 810, an outpatient consultation coverage field 811, a diagnostic testing coverage field 812, and an outpatient prescription coverage field 813. Each of the outpatient consultation coverage field 811, the diagnostic testing coverage field 812, and the outpatient prescription coverage field 813 may include a detailed description of the coverage, a patient co-pay/deductible amount 815 for the queried service and a coverage ratio beyond the patient co-pay/deductible 816 if the plan has a co-insurance benefit.

In some embodiments, the outpatient service confirmed GOP 801 may further include accumulating information such as the number of visits year to date, a complete estimated charge for the queried service, contact information, document list required to be submitted together with the confirmed GOP, etc.

In some embodiments, the outpatient service confirmed GOP 801 is configured to be able to share among the member, the healthcare insurer, a service provider, and a third party administrator.

According to some embodiments, a GOP may be exclusively connected with a particular service specifically defined within the description of service field 810. If additional medically necessary treatment is required that is not within the description of service field 810, a separate GOP may be requested and issued.

According to yet some other embodiments, the GOP may further include a maximum benefit of the guarantee of payment. Once the maximum benefit limit has been met, a separate GOP may be requested and issued.

According to the present invention, a direct-pay/cashless experience for doctor office visits and all other physician and hospital services outside the United States is possible for members with an international insurance carrier, thus providing the international insurance carrier an important competitive advantage.

Further, according to the present invention, the process to verify eligibility and benefit inquiries is more convenient by initiating the inquiries using a mobile application, a website browsing, a phone call, an e-mail, and a provider portal, etc. All parties including members, providers and payers may receive identical view of GOP within seconds. For simple outpatient procedures and office visits, GOP may be generated within ten to thirty seconds and delivered to provider and member with no need of human intervention. For more complex and/or costly procedures, business logic may route request for guarantee to case manager for medical review. Accordingly, the present invention may minimize administrative expenses by automating what is traditionally a manual process and handling increasing volumes at a low incremental cost.

Further, according to the present invention, GOP data processed in multiple languages and currencies may reduce errors and streamlining transactions, thus benefiting all parties including members, providers and payers.

Further, according to the present invention, the mCard system is developed using service oriented architecture (SOA), and therefore, it may be reusable for other insurance companies.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software, cloud or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method of retrieving healthcare information comprising:
at a computer having one or more processors and memory for storing one or more programs to be executed by the processors:
receiving a query for a service charge in connection with a member from a user terminal;
assigning a case number to the query for a service charge;
transmitting the query for a service charge to a healthcare insurer;
receiving a response to the query for the service charge in connection with the member from the healthcare insurer;
generating guarantee of payment (GOP) data in accordance to the response to the query for the service charge in connection with the member;
logging the GOP data in a database; and
outputting the GOP data to the user terminal.

2. The method of retrieving healthcare information in accordance with claim 1 further comprises:
applying language and currency conversions to the GOP data in accordance to a location where the service is provided.

3. The method of retrieving healthcare information in accordance with claim 2 further comprises:
applying business logic on the query for a service charge based on a plurality of factors, and transmitting the query for a human-intervened review before generating the GOP data.

4. The method of retrieving healthcare information in accordance with claim 1, wherein
the user terminal further comprises a website browsing terminal, a mobile optimized website, a mobile device compatible application, or an administrative interface.

5. The method of retrieving healthcare information in accordance with claim 1, wherein
the query for a service charge and the response to the query for a service charge are paired transactions configured to comply with a pre-defined format.

6. The method of retrieving healthcare information in accordance with claim 1, wherein
the GOP data includes a member responsible charge of the service.

7. The method of retrieving healthcare information in accordance with claim 1, wherein
the GOP data is configured to be able to share among the member, the healthcare insurer, a service provider, and a third party administrator.

8. A system of retrieving healthcare information comprising:
one or more processors;
memory for storing one or more programs to be executed by the processors;
a front-end receiver configured to receive a query for a service charge in connection with a member from a user terminal;
a query processor configured to assign a case number to the query for a service charge;
a rear-end transmitter configured to transmit the query for a service charge to a healthcare insurer;
a rear-end receiver configured to receive a response to the query for the service charge in connection with the member from the healthcare insurer;
a GOP processor configured to generate guarantee of payment (GOP) data in accordance to the response for the service charge in connection with the member;
a register configured to log the GOP data in the database; and
a front-end transmitter configured to output the GOP data to the user terminal.

9. The system of retrieving healthcare information in accordance with claim 8 further comprises:
a region converter configured to apply language and currency conversions to the GOP data in accordance to a location where the service is provided.

10. The system of retrieving healthcare information in accordance with claim 9 further comprises:
a business logic module configured to apply business logic on the query for a service charge based on a plurality of factors, and transmitting the query for a human-intervened review before generating the GOP data.

11. The system of retrieving healthcare information in accordance with claim 8, wherein
the user terminal further comprises a website browsing terminal, a mobile optimized website, a mobile device compatible application, or a GOP administrative interface.

12. The system of retrieving healthcare information in accordance with claim 8, wherein
the query for a service charge and the response to the query for a service charge are paired transactions configured to comply with a pre-defined format.

13. The system of retrieving healthcare information in accordance with claim 8, wherein
the GOP data includes a member responsible charge of the service.

14. The system of retrieving healthcare information in accordance with claim 8, wherein
the GOP data is configured to be able to share among the member, the healthcare insurer, a service provider, and a third party administrator.

15. A non-transitory computer readable storage medium, storing one or more programs for execution by one or more processors of a computer system, the one or more programs including instructions for:
receiving a query for a service charge in connection with a member from a user terminal;
assigning a case number to the query for a service charge;
transmitting the query for a service charge to a healthcare insurer;
receiving a response to the query for the service charge in connection with the member from the healthcare insurer;
generating guarantee of payment (GOP) data in accordance to the response to the query for the service charge in connection with the member;
logging the GOP data in a database; and
outputting the GOP data to the user terminal.

16. The non-transitory computer readable storage medium in accordance with claim 15, wherein the one or more programs further comprises:
applying language and currency conversions to the GOP data in accordance to a location where the service is provided.

17. The non-transitory computer readable storage medium in accordance with claim 16, wherein the one or more programs further comprises:
applying business logic on the query for a service charge based on a plurality of factors, and transmitting the query for a human-intervened review before generating the GOP data.

18. The non-transitory computer readable storage medium in accordance with claim 15, wherein
the user terminal further comprises a website browsing terminal, a mobile optimized website, a mobile device compatible application, or an administrative interface.

19. The non-transitory computer readable storage medium in accordance with claim 15, wherein
the query for a service charge and the response for a service charge are paired transactions configured to comply with a pre-defined format.

20. The non-transitory computer readable storage medium in accordance with claim 15, wherein
the GOP data includes a member responsible charge of the service.
